(19) United States
(12) Patent Application Publication
(10) Pub. No.: US 2006/0029109 A1
(43) Pub. Date: Feb. 9, 2006

(54) Playback of downloaded digital audio content on car radios

(75) Inventor: Dov Moran, Kfar Saba (IL)

Correspondence Address: DR. MARK FRIEDMAN LTD.;C/o Bill Polkinghorn, 9003 Florin Way, Upper Marlboro, MD, 20772, US

(73) Assignee: M-SYSTEMS FLASH DISK PIONEERS LTD.

(21) Appl. No.: 11/003,471

(22) Filed: Dec. 6, 2004

Related U.S. Application Data
(60) Provisional application No. 60/599,081, filed on Aug. 6, 2004.

(51) Int. Cl. H04J 3/02

(52) U.S. Cl. 370/538; 370/485

(57) ABSTRACT

Digital audio content is delivered to a non-volatile memory device, operatively connected to a car radio mounted in a motor vehicle, and played back using a playback effecter mounted in the motor vehicle. Exemplary playback effecters include but are not limited to buttons contained within the car radio, rear seat audio controls, voice command recognizers, and playback effecters physically mounted to a steering wheel of the motor vehicle. A car radio capable of generating speech from digital text content is disclosed. According to some embodiments, digital text content is delivered to the non-volatile memory device, and played back using the car radio capable of generating speech from digital text content.

### CROSS-REFERENCE TO RELATED APPLICATIONS

This application claims priority to U.S. Provisional Application Ser. No. 60/599,081, filed on Aug. 6, 2004, which is incorporated herein by reference in its entirety.

### FIELD OF THE INVENTION

The present invention relates to the distribution of personalized digital audio content to non-volatile memory devices, and to the playback of the digital audio content on playback devices including car radios.

### BACKGROUND OF THE INVENTION

Car radios are one of the most ubiquitous devices in the developed world. In recent years, the radio receiver component of car radios has been augmented with features such as equalizer bands, CD players, the ability to read MP3 files, devices that automatically mute the car radio when a call is answered on a mobile telephone, textual display describing music content, etc. Despite these developments, there is an ongoing demand for accessing richer libraries of audio content including music and talk content from within motor vehicles.

One salient feature of car radios is their physical integration within the motor vehicle in which they are mounted. Thus, car radios are situated for convenient operation by a driver or front seat passenger with minimal distraction, and speakers are available with acoustical properties specific for the car in which they are mounted. In recent years, additional car radio components have become available to further enhance car radio operation, including controls mounted in the steering wheel and rear seat audio controls.

U.S. Pat. No. 6,253,237, incorporated herein by reference in its entirety, discloses an internet-based method for using a library access device such as a personal computer to download digital audio content to playback devices operatively connected to the library access device. Specifically, U.S. Pat. No. 6,253,237 discloses playing back digital audio content on portable playback devices and on playback devices operatively connected to the library access device. Content is downloaded directly to the playback device from the static content library according to a user's personal preferences. U.S. Pat. No. 6,253,237 does not disclose transferring stored content to a radio mounted in a motor vehicle. Although methods exist for delivering personalized digital audio content to portable playback devices operatively connected to a personal computer, there is an ongoing need for methods for delivering digital audio content to car radios which are mounted in motor vehicles.

A huge quantity of information is being continuously created and made textually available via electronic communications systems. There is so much information that it is simply not possible for an individual person to read it all. Much of the electronically-provided news information ages rapidly, such that it loses its relevancy in a matter of days, or even a matter of hours (e.g., stock market information). In light of the foregoing, there is clearly a need for systems and methods to allow people to conveniently access this textual information.

There is an ongoing need for techniques for targeted delivery of content to playback devices mounted in motor vehicles. Over the past few decades, traffic conditions in large number of metropolitan areas worldwide have worsened, generating a need to make this time more pleasant and productive. Furthermore, as the amount of textual content increases in accordance with the oft-lamented “information overload,” there is an ongoing need for tools to facilitate the process whereby people can consume more of this ever-increasing corpus of information in the most convenient manner possible.

### SUMMARY OF THE INVENTION

The aforementioned needs are satisfied by several aspects of the present invention.

In accordance with some aspects of the present invention, a method for delivering digital audio content to a non-volatile memory device and playing the delivered audio digital content on a car radio is disclosed. This method includes providing a non-volatile memory device, selectively downloading digital content to the non-volatile memory device, operatively connecting the non-volatile memory device to a car radio mounted in a motor vehicle, and playing the audio content on the car radio, while the non-volatile memory device is operatively connected to the car radio, using a playback effecter mounted in the motor vehicle.

Advantageously, methods of the present invention enable playback of downloaded digital audio content using playback effecters designed for use in a motor vehicle, and as such allow for a driver to play downloaded digital audio content in a manner that minimally distracts him or her from the task of operating the motor vehicle. In accordance with the present invention, it is possible to benefit from downloaded digital audio content without operatively connecting the car radio to a library access device such as a personal computer.

Any playback effecter mounted in the motor vehicle is appropriate for the methods provided by the present invention. Thus, in some embodiments, digital audio content is played back using a playback effecter physically contained within the car radio, such as one or more buttons. In some embodiments, the playback effecter is physically mounted to the steering wheel of the motor vehicle. In some embodiments, the playback effecter includes a voice command recognizer.

In some embodiments, the playback effecter includes rear seat audio controls. Thus, embodiments of the present invention fulfill an ongoing need of providing personalized downloaded digital content to motorists not sitting adjacent to the car radio.

In some embodiments, content downloaded to the non-volatile memory device is provided over the Internet.

In some embodiments, the digital audio content is downloaded using an access device. Exemplary access devices include but are not limited to personal computers, personal digital assistants, and cell phones.

In some embodiments, the non-volatile memory device physically contacts the car radio. In other embodiments, the digital audio content is transferred to the playback device using a wireless connection.

Any appropriate non-volatile memory device known in the art is appropriate for the present invention. In certain embodiments, the non-volatile memory device is a USB flash disk. In some embodiments, the non-volatile memory device is a USB flash disk that lacks a playback device.

In accordance with some aspects of the present invention, audio content appropriate for specific locations is played back in a car radio. Thus, according to some embodiments, the playback effecter is operatively connected to an onboard navigation device. This allows, for example, for downloaded traffic information to be played back when a motor vehicle reaches a locale where there is potential traffic congestion, allowing motorists to judiciously choose an alternative route.

In some embodiments, localized content is provided in accordance with a provided description of a geographic location, such as a driving route, and listened to on the car radio.

Any digital audio content known in the art is appropriate for downloading and listening in accordance with the present invention. Exemplary digital audio content includes but is not limited to music, traffic information, commercial messages, weather information, audio books, recorded radio programs and news reports.

In some embodiments, the traffic conditions are downloaded in accordance with a provided description of a geographic location. In some embodiments, the description includes a driving route.

It is now disclosed that portable non-volatile memory devices are an excellent conduit for delivery of audio content including dynamic digital textual content transformed into audio content.

According to some aspects, the present invention provides a method for playing audio content. This method includes providing a non-volatile memory device for storing digital content, selectively downloading the digital content including digital text content to the non-volatile memory device, operatively connecting the non-volatile memory device to a car radio capable of transforming the digital text content to transformed audio content, the car radio mounted in a motor vehicle and playing the audio content including the transformed audio content on the car radio while the non-volatile memory device is operatively connected to the car radio.

According to some embodiments, the method further comprises viewing the digital textual content on a device selected from the group consisting of a personal computer, a cell phone, and a personal digital assistant.

Any digital textual content is appropriate for the present invention. According to exemplary embodiments, the digital textual content is in a file format selected from the list consisting of text, Microsoft Word®, Microsoft Power Point®, html, xml, sgml, PDF, and Microsoft Excel®.

In particular embodiments, users decide after listening to transformed audio content that it is nevertheless worthwhile to visually peruse a portion of this content after all. One example is a user who listened to a series of help-wanted ads on a playback device and was specifically interested in a particular subset of these ads. According to embodiments of the present invention, users may read downloaded textual digital content using, for example, a personal computer.

According to some embodiments, the digital content further includes digital audio content and the step of the playing audio content includes playing the digital audio content.

It is now disclosed for the first time a system for listening to digital audio content according to location including a car radio including a playback effecter and an onboard navigation device, wherein the playback effecter is operatively connected to the onboard navigation device.

According to some embodiments, the system further comprises a non-volatile memory device operatively connected to said car radio.

According to some embodiments, the non-volatile memory device includes a flash memory device.

It is now disclosed for the first time a car radio capable of generating speech from digital text content.

According to some embodiments, the car radio is mounted in a motor vehicle, and operatively connected to a playback effecter mounted in the motor vehicle.

According to some embodiments, the car radio capable of generating speech from digital text content is operatively connected to a non-volatile memory device, and receives digital text content and optionally digital audio content from the non-volatile memory device.

These and further embodiments will be apparent from the detailed description and examples that follow.

### BRIEF DESCRIPTION OF THE DRAWINGS

FIG. 1A provides a block diagram of some exemplary embodiments of the present invention.

FIG. 1B provides a block diagram of some exemplary embodiments of the present invention.

FIG. 2 provides a flow chart of exemplary embodiments of the present invention wherein localized digital audio content is delivered to a non-volatile memory device.

FIG. 3 provides a flow chart of exemplary embodiments of the present invention wherein converted textual content is delivered to a non-volatile memory device.

FIG. 4 provides a flow chart of exemplary embodiments of the present invention wherein digital audio content is delivered to a non-volatile memory device in a quantity determined in part by a calculated driving time along a driving route.

### DETAILED DESCRIPTION OF THE INVENTION

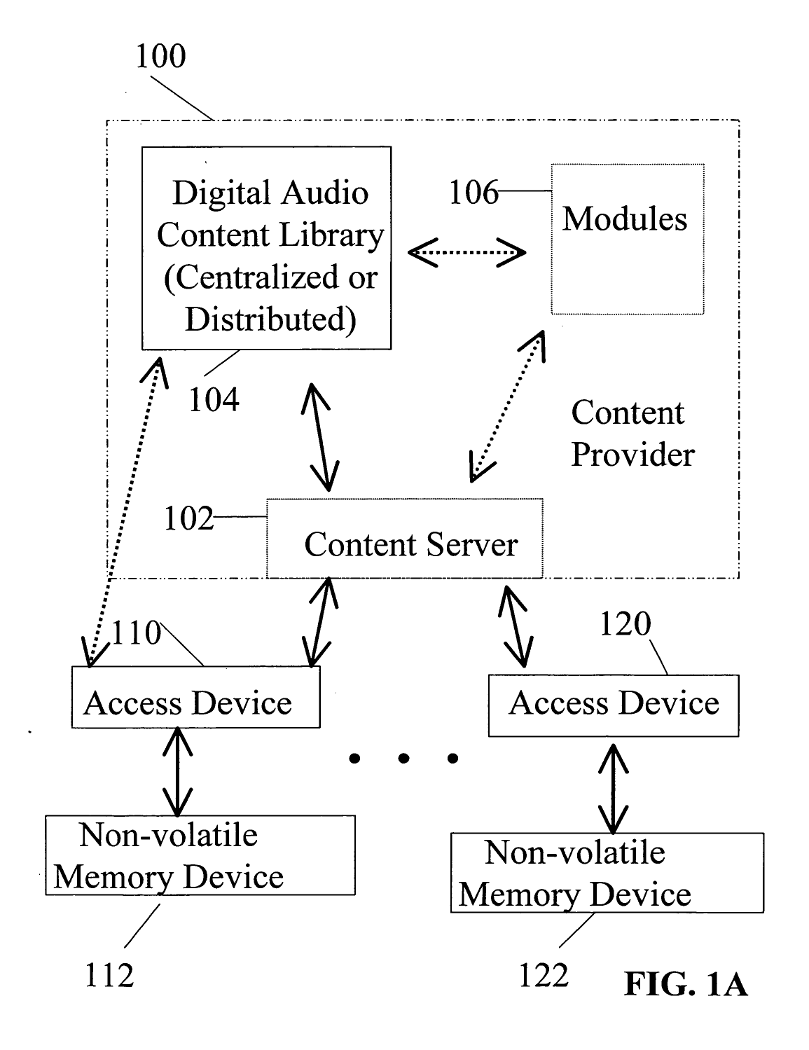

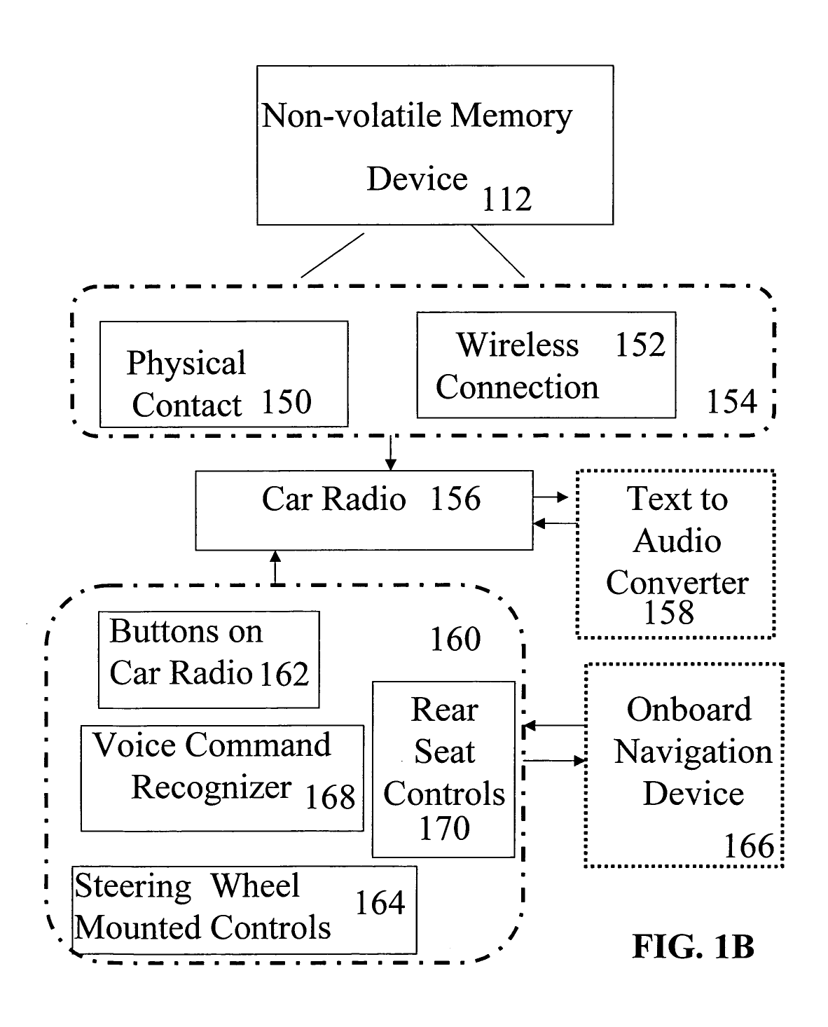

FIG. 1A provides a block diagram describing exemplary embodiments of the present invention. Digital audio content is delivered from a Content Provider 100 to an Access Device 110 and is subsequently transferred or copied to a Non-volatile Memory Device 112. Non-volatile Memory Device 112 is optionally a portable memory device. Digital audio content encoded in any file format is appropriate, including those formats currently used and those formats that have not yet been defined. Exemplary file formats include but are not limited to WMA, MP3, MIDI, VOX, WAV, AIFF, etc.

Typically, Access Device 110 is a microcomputer, though in alternate embodiments Access Device 110 is, for example, a handheld computing device such as a Personal Digital Assistant (PDA) or a cell phone. In one exemplary embodiment, Access Device 110 is a microcomputer, and Content Provider 100 includes one or more optional Content Servers 102 configured to deliver digital audio content to Access Device 110. Access Device 110 communicates with the Content Servers 102 using, for example, a wide area network, a wireless connection, the Internet, a direct connection such as a data bus, or though a local area network (LAN). Although Content Provider 100 and Access Device 110 are illustrated as separate devices in FIG. 1A, this is not a requirement for the present invention, and in alternate embodiments, Content Provider 100 and Access Device 110 reside on a single computer. In one exemplary embodiment, Access Device 110 includes a microcomputer, and part or all of a Digital audio Content Library 104 is on a peripheral storage device of the microcomputer, for example on a hard disk, a CD-ROM drive, a DVD drive, and the like.

Embodiments of the present invention provide for both a centralized as well as a distributed Digital audio Content Library 104. In particular embodiments, digital audio content library 104 provides digital audio content. Exemplary content includes but is not limited to music, audio books, recorded radio programs, recorded lectures, audio newsletters, audio periodicals, audio portions of television programming, audio messages or other communications from individuals, etc.

It is understood that in some embodiments more than one access device receives content from a single content provider, as illustrated in FIG. 1A wherein Access Device 110 transfers content received from Content Provider 100 to Non-volatile Memory Device 112, and a second Access Device 120 transfers content received from Content Provider 100 to a second Non-volatile Memory Device 122. Furthermore, it is understood that a single Access Device 110 in certain embodiments transfers content to more than one Non-volatile Memory Device.

As used herein, “downloaded” content is content retrieved either through a local area network (LAN), the Internet, from a hard drive or other peripheral of the Access Device 110, or over a wide area network (WAN).

According to some particular embodiments, different versions of the same content become available as a function of time. For example, different versions of traffic reports for the same geographic location become available as local traffic condition change. These different versions are available through Content Provider 100, optionally through one of the one or more optional Modules 106.

According to some embodiments, Modules 106 are for providing specific information. Exemplary Modules 106 include but are not limited to a Personalization Server, a Map Database, a Current Traffic Conditions Database, a Traffic Mathematical Modeler, a Directions Database, a Directions Database capable of giving directions in accord with local traffic conditions, a Text Server, a Text to Audio Content Converter, and a Route Calculator (not shown).

In particular embodiments, the content already on Non-volatile Memory Device 112 is updated, as newer versions of the content become available at the Content Provider 100. In one exemplary embodiment, this updating is carried out by erasing at least some of the content to be updated on the Non-volatile Memory Device 112, and replacing this content with a newer version.

In some embodiments, the Non-volatile memory device includes a flash memory device. A typical Non-volatile Memory Device appropriate for the present invention is the DiskOnKey® available from M-Systems (Newark, Calif.). Any non-volatile memory device is appropriate for the present invention, including those that include a playback device, and those that lack a playback device.

The optional one or more Content Servers 102 receive content from a Centralized or Distributed Digital audio Content Library 104, via a local area network, or via a wide area network including the Internet. Furthermore, Content Server 102 in certain embodiments delivers content in conjunction with one of Modules 106.

As used herein, the term “text content” is any textual content available in any of a variety of file formats, such as text, Microsoft Word®, Microsoft Power Point®, html, xml, sgml, PDF, Microsoft Excel®, etc. In one exemplary embodiment, the textual content is saved as non-textual data such as an image, and software is available for extracting the textual content from the non-textual data.

As used herein, “transforming” or “converting” digital text content to transformed audio content includes speech generation from text and/or converting digital text content to digital audio content. As used herein, “transformed audio content” includes actual speech content that is played back and/or digital audio content optionally stored to a file. Thus, in some embodiments a car radio capable of transforming digital text content to transformed audio content first creates digital audio content and optionally saves this digital content to volatile and/or non-volatile memory. In some embodiments, no digital audio content is stored in memory, and the transforming process directly includes generation of actual speech from digital text content without forming or storing of digital audio content.

Algorithms for text to speech conversion are known in the art, especially in the field of telecommunications. Any known method of text to speech conversion is appropriate for embodiments of the present invention. Exemplary methods for text to speech conversion include but are not limited to those methods disclosed in U.S. Patent Application 2004/0215462 entitled “Method of generating speech from text” and incorporated herein by reference in its entirety. As used herein, the term “UFD” refers to a Universal Serial Bus flash disk.

In particular embodiments, the Personalization Server is a web server with a database. In further embodiments, a user with a Web browser visits a web site provided by the Personalization Server, registers, and enters in his or her user preferences.

After content is copied or transferred to Non-volatile Memory Device 112, a user listens to the digital audio content using a playback device. In a preferred embodiment, the playback device is a car radio.

FIG. 1B provides a schematic diagram describing consumption of downloaded digital audio content and optionally digital text content using a Car Radio 156. The digital audio content and optionally text content is stored on the Non-volatile Memory Device 112, and is delivered to the Car Radio 156 through an appropriate interface 154. In some embodiments, this interface 154 includes physical contact 150 between the Non-volatile Memory Device 112 and the Car Radio 156. In other embodiments, the Non-Volatile Memory Device 112 delivers content for playback to the car radio 156 using a wireless connection 152. In some embodiments, the radio receiver of the car radio 156 receives the content from a local radio transmitter. Local radio transmitters including a USB port for transmitting digital audio content from a non-volatile memory device 112 are available from Primary Simulation Inc. (Silver Spring, Md.).

The playback of digital audio content is controlled by a Playback Effecter 160. As used herein, a “playback effecter” is a physical control used to turn the car radio on, cause the car radio to play certain content, cause the car radio to stop playing content, cause the car radio to fast forward or rewind (either within tracks or between tracks), raise or lower the volume. Examples of playback effecters 160 are buttons within the car radio 156, voice recognition devices 168, controls embedded in the steering wheel 164, or other controls such as rear seat controls 170 mounted to the rear seat of the motor vehicle.

Optionally, the car radio 156 is operatively connected to an Onboard Navigation Device 166, and the car radio 156 plays back content stored on the Non-volatile memory device 112 in accordance with instructions received from the Onboard Navigation Device 166. In exemplary embodiments, the Onboard Navigation Device 166 includes a Global Positioning Device. In exemplary embodiments, downloaded traffic information stored on the Non-volatile memory device 112 is played back on the car radio 156 when a motor vehicle reaches a locale where there is potential traffic congestion, allowing motorists to judiciously choose an alternative route. In exemplary embodiments, certain music tracks are played when the car reaches certain locations. For example, soothing music is played when the Onboard Navigation Device 166 indicates that the motor vehicle has received a high-congestion traffic region.

### Additional Embodiments for Distribution of Digital Audio and Textual Content

Although car radios have been improved upon for decades, car radios retain their original functionality as a reception device for audio content transmitted by local radio stations. Both local radio stations as well as playback devices associated with car radios provide music and other audio content to the driver and passengers. Nevertheless, local radio stations excel at providing specific localized content such as citywide traffic reports, local news and weather, commercial messages for products and services that are locally available, and the like.

In recent years, the corpus of localized content available through various channels has grown tremendously. For example, localized text-based discussion forums are available on the Internet at sites including those hosted by CraigsList (San Francisco, Calif.) and Yahoo! (Sunnyvale, Calif.). Directions between a starting point and destination are available using services such as Time Warner's MapQuest (New York, N.Y.). On-board GPS based navigation systems have become more popular in recent years. Various location based services are also available from mobile phone providers, and can provide users of these services information about local points-of-interest such as gas stations, restaurants, nightclubs, etc. As opposed to the metropolitan-area localized content provided by local radio stations, much of the localized content supplied by mobile phone and GPS devices is personalized in nature.

Furthermore, much of the aforementioned localized content is visually presented, and does not necessarily lend itself to consumption by drivers and passengers who often exhibit a strong preference for audio content, especially when the motor vehicle is in motion. There is an ongoing need for methods and apparatus for providing localized audio content and other audio content to motorists.

In general, localized content broadcast by local radio stations is created specifically for a given city or metropolitan area, and in certain circumstances may be of diminished relevance for users interested in content related to a targeted location or driving route within the metropolitan area. For example, as many residents of large metropolitan areas know, the traffic reports provided by local radio stations do not usually divulge necessary information about every specific traffic problem within the metropolitan area. Furthermore, traffic reports are typically broadcast every five or ten minutes or less often on the radio, and in many cases motorists are forced to listen carefully to more than one irrelevant traffic reports before receiving the relevant localized traffic reports they are seeking, if at all. There is an ongoing need for techniques for delivering targeted localized audio traffic reports.

Thus, although local radio stations can indiscriminately target content for a locale the size of a town or metropolitan area, there is an ongoing need for content targeted to specific locations within this metropolitan areas. This ongoing need also applies to audio commercial messages. Purchasers of these commercial messages are often constrained by budgetary concerns when weighing a decision to purchase a specific commercial message on a local radio station. On the one hand, the commercial messages are often priced according to the total number of listeners receiving a given commercial message. On the other hand, the purchaser of the commercial message knows that only a fraction of the listeners are potential consumers of a product or service being advertised. This situation is exacerbated by the fact that those forced to listen to irrelevant commercial messages often consider these irrelevant messages to be irksome. As such, there is an ongoing need for appropriate business methods for targeting localized commercial messages embedded in other audio programming. In particular, there is an ongoing need for appropriate business methods for targeting such audio commercial messages to motorists who have an elevated interest in localized content.

In accordance with some aspects of the present invention, a method for delivering localized and optionally personalized digital audio content to a non-volatile memory device is provided. This method includes providing a description of at least one geographic location, and delivering to a non-volatile memory device digital audio content including localized digital audio content related to the described at least one provided geographic location.

According to various embodiments, the geographic location includes at least one street address. According to specific embodiments, the description includes a driving route.

Unlike current techniques of delivering localized content to mobile phones or Global Positioning Devices, embodiments of the present invention conveniently provide for the embedding of pertinent localized content within other audio content including music and speech content. This pattern of consuming pertinent localized content embedded in other non-localized audio content has been prevalent for decades, especially for listeners consuming audio content in a motorized vehicle. Embodiments of the present invention enable users to benefit from an expanded corpus of personalized local content specifically adapted to a geographic location or driving route without requiring the users to modify listening habits.

Furthermore, embodiments of the present invention provide targeted localized content using low cost widely available components including USB non-volatile disks and personal computers, without a need to for Global Positioning Devices.

For specific embodiments, the localized content includes time relevant content localized, and a user intends to listen to the audio content at a time after the delivery of the digital audio content to the non-volatile memory device. Thus, in particular embodiments, the present invention allows for the delivery of at least some localized content in accordance with a specified time. In some embodiments, this specified time is a planned departure time. In exemplary embodiments, the localized content includes traffic reports, and the delivered traffic reports reflect estimated local traffic conditions in accordance with a specified departure time.

According to some embodiments, at least some digital audio content is delivered according to at least one user preference.

Any localized audio content is appropriate for delivery in accordance with embodiments of the present invention. Exemplary pertinent localized content include but are not limited to traffic reports optionally customized for a specific driving route, commercial messages optionally customized for Points of Interest proximate to specific street addresses, street directions optionally generated in accord with local traffic conditions, local crime news, local sports news reports, local weather reports, local news reports, and local commercial messages.

According to some embodiments, at least some of the localized digital audio content is generated in accordance with estimated local traffic conditions.

According to some embodiments, estimated local traffic conditions are ascertained based upon observed traffic conditions, historical traffic conditions, and/or outputs of mathematical models of traffic conditions.

According to some embodiments, at least some of the digital audio content is selected from the group consisting of road directions, music and commercial messages.

According to certain embodiments of the present invention, the delivered digital audio content further includes music, audio books, recorded radio programs, recorded lectures, audio periodicals, audio portions of television programming, and other audio messages.

Any non-volatile memory device is appropriate for embodiments of the present invention, including non-volatile memory devices that include a playback device, and USB non-volatile disks that lack playback devices. Embodiments of the present invention provide the benefits of portable localized audio content delivered to a non-volatile memory device, with opportunities to personalize this content using, for example, a personal computer or PDA as an access device. In yet another embodiment, the quantity of audio digital content delivered to a particular non-volatile memory device is automatically derived from a driving time calculated according to a provided driving route, thereby freeing the user from the burdensome task of manually downloading a specific quantity of audio content for a planned trip. In particular embodiments, this driving time is derived in accordance with estimated local traffic conditions.

According to certain embodiments, the localized content is consumed in a playback device in a motorized vehicle, wherein the playback device is optionally mounted in the motorized vehicle.

According to some embodiments, the delivering of digital audio content includes the step of downloading the digital audio content to an access device, and transferring the digital audio content to the non-volatile memory device from access device.

In some embodiments, the downloading includes downloading at least some of the digital audio content from a central server.

In some embodiments, the downloading includes downloading at least some of the digital audio content from a plurality of distributed servers.

It is now disclosed that portable non-volatile memory devices are an excellent conduit for delivery of digital audio content including localized digital audio content related to at least one geographic location, and including dynamic digital textual content culled from a server providing dynamic textual digital content and converted into digital audio content. Examples of dynamic textual digital content include user discussion groups, help wanted advertisements, on line news, stock quotes, and other textual content including search engine results. Much of this time-dependent dynamic textual content is not necessarily considered critical, and users are often unwilling to invest otherwise productive hours perusing this content visually. Users nevertheless consider this content desirable to consume, albeit with a minimal investment of productive time. Embodiments of the present invention provide users with opportunities to consume the converted audio content using otherwise less productive travel time, and providing a solution for this long-felt need. Advantageously, embodiments of the present invention where the access device is a personal computer provide a traditional, PC-based content personalization interface without the concomitant visual time commitment entailed in reading the consumed textual content.

According to some other aspects, the present invention provides a method for delivering audio content to a non-volatile memory device, including sending a query to a text content server, obtaining dynamic digital textual content according to the query, converting the dynamic digital textual content stored in memory into converted digital audio content, and delivering the converted digital audio content to the non-volatile memory device.

Exemplary queries include but are not limited to search engine queries.

In some embodiments, the query includes a description of at least one geographic location.

In some embodiments, the textual content server is a discussion group server. In particular embodiments, users decide after listening to converted audio content that it is nevertheless worthwhile to visually peruse a portion of this content after all. One example is a user who listened to a series of help-wanted ads on a playback device and was specifically interested in a particular subset of these ads. Embodiments of the present invention provide for the concomitant delivery of the unconverted dynamic textual content together with the converted audio content, providing an opportunity for the user to “scan” audio content while traveling and to subsequently read a selected subset. In one specific embodiment, metadata relating the converted content to the textual content is delivered to the non-volatile memory device, aiding the process of locating target text content.

It is now disclosed for the first time a method of delivering digital audio content to a non-volatile memory device for playback on a playback device, wherein at least some of the digital audio content is delivered in accordance to local traffic conditions. In one embodiment, music is delivered according to the local traffic and/or weather conditions. For example, for driving in heavy traffic, soothing music is delivered, while more upbeat music is delivered for low-traffic highway driving. For these embodiments, the present invention obviates the stress associated with driving in traffic, addressing yet another long-felt need.

In yet other embodiments, embedded commercial message content is delivered according to local traffic conditions. In one exemplary embodiment, fewer commercial messages are delivered for heavy traffic, while more commercial messages are delivered for lighter traffic and highway driving when a listener is more amenable to hearing such messages.

It is now disclosed for the first time a business method wherein digital audio content including localized commercial messages is delivered to a non-volatile memory device for listening in a playback device. In particular embodiments, the localized commercial messages are related to user-provided geographic locations, particularly user-provided driving routes. Thus, those purchasing the commercial messages pay to deliver these messages only to potential customers who will purportedly be in geographical proximity of a commercial point of interest such as a store, restaurant, or gas station. Similarly, users have their listening experience interrupted only by more pertinent commercial messages. For certain embodiments of the present invention, the localized commercial message content is to be personalized, with a user, for example, selecting that s/he is interested in restaurants in a certain geographic area. These embodiments are particularly advantageous for tourists driving in a specific metropolitan area. Furthermore, because most playback devices allow users to repeat specific audio content, embodiments of the present invention allow the users to rehear particularly pertinent commercial messages in which they are interested.

According to some aspects, the present invention provides a business method for a targeted distribution of localized audio commercial messages for consumption on a playback device in a motor vehicle. This method includes providing a description of a driving route and delivering to a non-volatile memory device digital audio content including at least one commercial message, wherein at least one commercial message is related to a location in proximity to at least one point on the described driving route.

According to other aspects, the present invention provides a business method for the targeted distribution of localized audio commercial messages for consumption on a playback device in a motor vehicle. This method includes providing a description of a driving route, ascertaining local traffic conditions along the driving route, and delivering to a non-volatile memory device digital audio content including at least one commercial message wherein at least one commercial message is delivered in accordance with the local traffic conditions.

According to some aspects, the present invention provides a method for delivering digital audio content to a non-volatile memory. The method includes providing a driving route, estimating a driving time along the driving route, and delivering a quantity of digital audio content to the non-volatile memory device in accordance with the driving time and in accordance with the storage capacity of the non-volatile memory device.

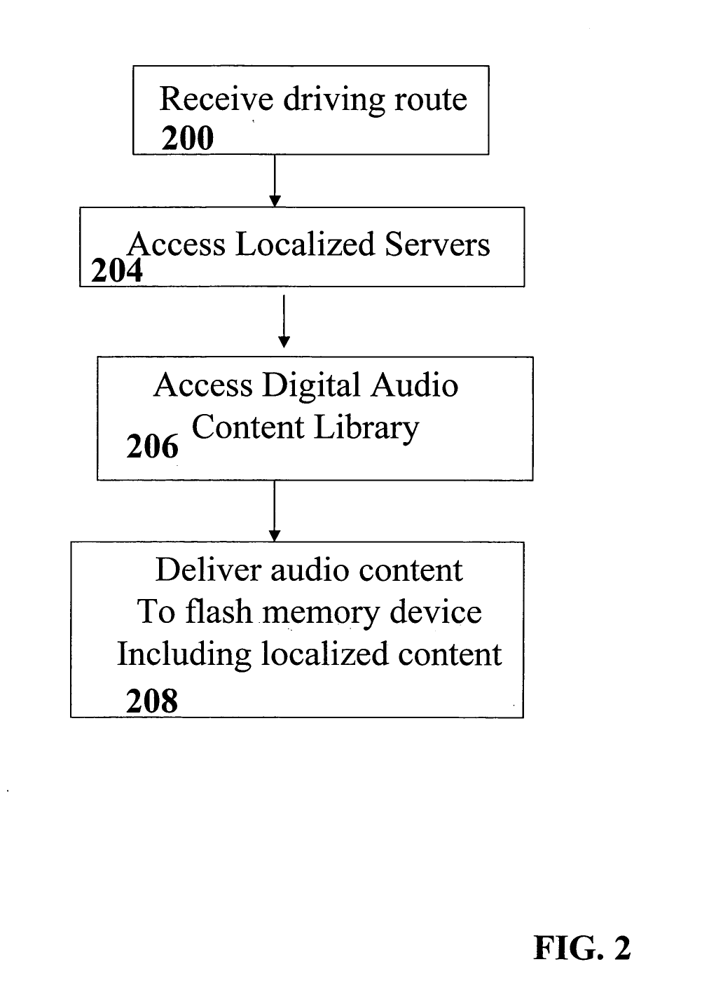

FIG. 2 provides a flow chart of a typical embodiment wherein Content Server 102 delivers digital audio content in accord with instructions and/or content received from the one or more Modules 106.

First the user provides (200) a driving route using Access Device 110. Alternately, the user's driving route in certain embodiments is a previously provided route stored within Content Provide 100. Content Server 102 next accesses (204) localized servers in order to retrieve localized information necessary for providing localized audio content. Exemplary localized servers include but are not limited to a map server including a map database; a traffic conditions server including data about local traffic conditions observed by a human observer and entered into a database, or data automatically retrieved from roadside sensors, or a traffic conditions server providing estimated traffic conditions based upon historical data or mathematical models, or a combination thereof; a directions server which provides directions in accordance to data from the map server and optionally in accordance with the traffic conditions server; and a commercial content server which provides commercial content in accord with points-of-interest in proximity of the driving route. Traffic conditions include any information about local traffic conditions, including but not limited to the level of traffic congestion, road construction report, bridge closings information, and toll information.

In certain embodiments, the phrase “in proximity of” as used herein implies no more than 10 kilometers from a specific location such as a point on a described driving route.

In certain embodiments, the phrase “in proximity of” as used herein implies no more than 2 kilometers from a specific location such as a point on a described driving route.

In certain embodiments, the phrase “in proximity of” as used herein implies no more than 500 meters from a specific location such as a point on a described driving route.

In certain embodiments, the phrase “in proximity of” as used herein implies no more than 100 meters from a specific location such as a point on a described driving route.

Next, Content Server 102 optionally provides (206) non-localized digital audio content accessed from digital audio content library 104. In particular embodiments, the localized content is embedded in the non-localized content as is done with local radio broadcasts. Finally, Access Device 110 retrieves content from Content Provider 100 and delivers this content to Non-volatile Memory Device 112.

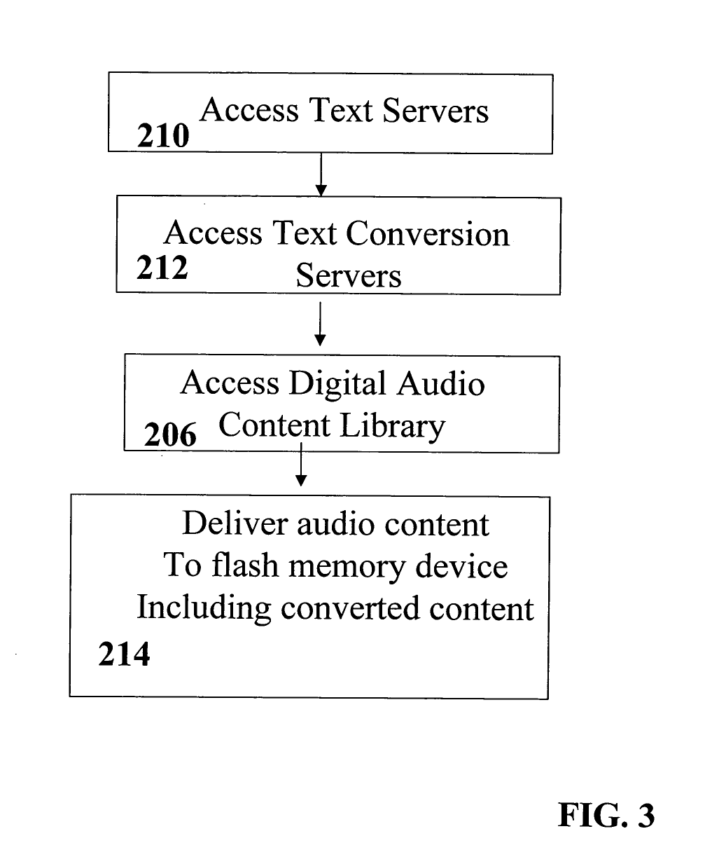

FIG. 3 provides a flow chart of a typical embodiment wherein Content Server 102 delivers digital audio content including converted text content, wherein Modules 106 include a text server and a text conversion server that provide converted text content to Content Server 102.

As used herein, “dynamic” content includes textual content available on a server wherein the server is periodically updated, thereby altering the textual content. Examples of dynamic content include but are not limited to textual content available on a web server such as discussion group content and employment ads, textual content available on a bulletin board system, and textual content available on a file server.

Embodiments of the present invention provide content which is “culled,” or selectively downloaded, from a textual content server.

First, a text server is accessed (210). In various embodiments this text server is a library-like repository, a local machine such as Access Device 110, a file server providing textual content over a local area network, or alternately is a publicly available server accessed over the Internet. After the text is accessed, digital audio content is created (212) by accessing a text conversion server. Optionally, this converted text is embedded in other digital audio content (206) provided by Digital audio Content Library 104. Finally, (214) Access Device 110 retrieves content from Content Provider 100 and delivers this content to Non-volatile Memory Device 112.

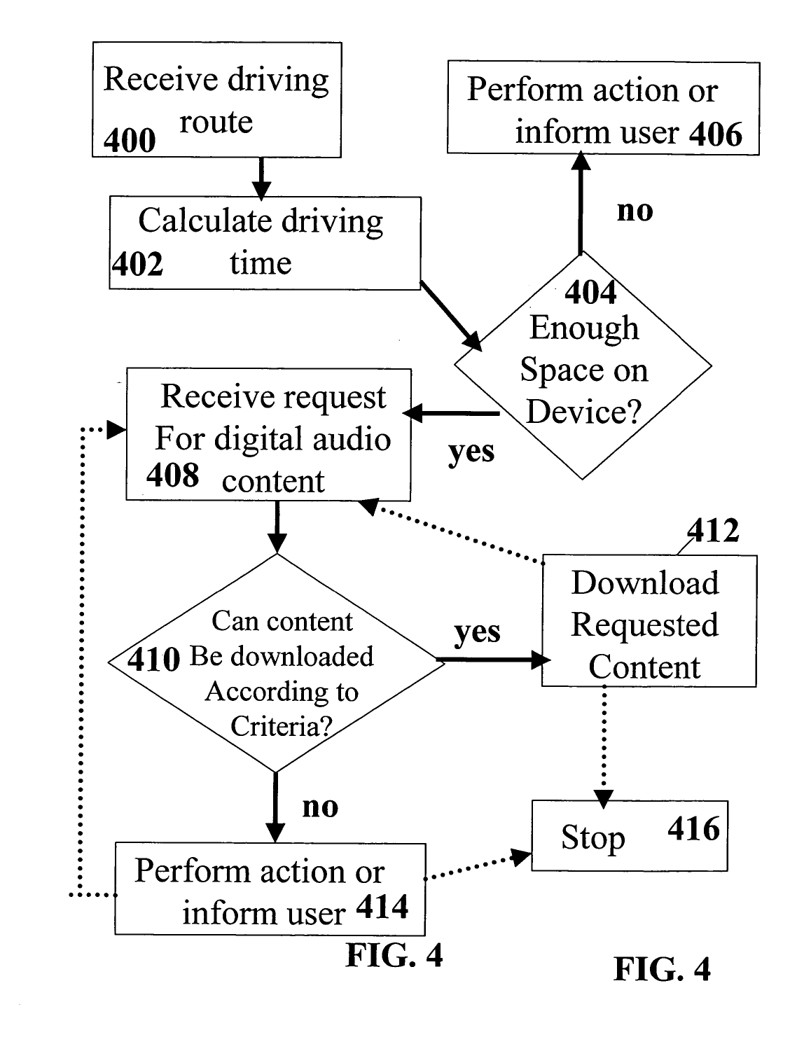

It is now disclosed for the first time a method of providing a quantity of digital audio content to a non-volatile memory device wherein the provided quantity of delivered digital audio content is derived from a calculated driving time along a specific driving route. FIG. 4 provides a flow chart of exemplary embodiments of this method.

First, a driving route is received (400) and a driving time along this route is calculated (402). Next, either the Access Device 110 or the Content Provider 100 or a Module 106 therein optionally estimates 404 the storage space necessary to store a quantity of audio content according to the calculated driving time. It is understood that this is merely an estimate, and it is not always possible to exactly compute the necessary storage space, as this varies according to file format, and other factors. Optionally, the user provides some of these parameters. In the event that the Access Device 110 or the Content Provider 100 or a Module 106 therein estimates that the non-volatile memory device does not have enough space, the user is informed (406) and is given the option to deliver digital audio content to the non-volatile memory device in any case.

Next, a request for digital audio content is received (408). In particular embodiments, this request is part of a pre-determined request list, or a playlist, etc. or is in accordance with other mechanisms of delivering digital audio quantity. In other embodiments, it is user-supplied.

Before this content is downloaded to non-volatile memory device 112, it is decided if the content can be downloaded (410). This decision is based upon checking for sufficient space on the non-volatile memory device, and by adding the time of content already downloaded to the time of content to be added in order to verify that the total playback time of the quantity of content to be delivered to the non-volatile memory device does not exceed the calculated driving time.

In the event that the playback time of the content to be delivered does exceed the calculated driving time, the user is informed (414) and is given the option to proceed with the download. In other embodiments, the user is not explicitly informed, and the software is programmed with parameters informing whether to proceed with the download, or execute any other step in this method where informing the user is specified. Otherwise, the requested downloaded content is downloaded.

In particular embodiments, Non-volatile Memory Device 112 includes a playback device, and a user listens to the digital audio content using Non-volatile Memory Device 112. In other embodiments, Non-volatile Memory Device 112 lacks a playback device.

The numerous innovative teachings of the present application are described below with particular reference to the presently preferred embodiment. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A method for playing digital audio content, comprising:
a) providing a non-volatile memory device for storing the audio content;
b) selectively downloading the digital audio content to said non-volatile memory device;
c) operatively connecting said non-volatile memory device to a car radio mounted in a motor vehicle; and
d) playing said digital audio content on said car radio, while said non-volatile memory device is operatively connected to said car radio, using a playback effecter mounted in said motor vehicle.

2. The method of claim 1 wherein said playback effecter is physically mounted to a steering wheel.

3. The method of claim 1 wherein said playback effecter includes a voice command recognizer.

4. The method of claim 1 wherein said playback effecter includes rear seat audio controls.

5. The method of claim 1 wherein said playback effecter is contained within said car radio.

6. The method of claim 1 wherein said playback effecter is operatively connected to an onboard navigation device.

7. The method of claim 1 wherein said digital audio content is downloaded to said non-volatile memory device in accordance with a provided description of one or more geographic locations.

8. The method of claim 1 wherein said downloading includes receiving said digital audio content over the Internet.

9. The method of claim 1 wherein said non-volatile memory device physically contacts said car radio.

10. The method of claim 1 wherein said digital audio content is transferred to said car radio from said non-volatile memory device using a wireless connection.

11. The method of claim 1 wherein said non-volatile memory device is a UFD (USB flash disk) that lacks a playback device.

12. The method of claim 1 wherein said digital audio content is downloaded according to at least one user preference.

13. The method of claim 1 wherein said digital audio content includes digital audio content selected from the group consisting of music, traffic information, weather information, news, commercial messages, audio books, recorded radio programs, recorded lectures, audio newsletters, audio periodicals, audio portions of television programming, audio message and road directions.

14. A method for playing audio content comprising:
a) providing a non-volatile memory device for storing digital content;
b) selectively downloading said digital content including digital text content to said non-volatile memory device;
c) operatively connecting said non-volatile memory device to a car radio capable of transforming said digital text content to transformed audio content, said car radio mounted in a motor vehicle; and
d) playing audio content including said transformed audio content on said car radio while said non-volatile memory device is operatively connected to said car radio.

15. The method of claim 14 wherein said non-volatile memory device is a USB non-volatile memory device that lacks a playback device.

16. The method of claim 14 further comprising the step of:
e) viewing said digital textual content on a device selected from the group consisting of a personal computer, a cell phone, and a personal digital assistant.

17. The method of claim 14 wherein said digital textual content is in a file format selected from the list consisting of text, Microsoft Word®, Microsoft Power Point®, html, xml, sgml, PDF, and Microsoft Excel®.

18. The method of claim 14 wherein said digital content further includes digital audio content and said step of the playing audio content includes playing said digital audio content.

19. A method for delivering digital audio content to a non-volatile memory device of a certain storage capacity, the method comprising:
a) providing a driving route;
b) estimating a driving time along said driving route; and
c) delivering a quantity of digital audio content to the non-volatile memory device in accordance with said driving time and in accordance with the storage capacity of the non-volatile memory device.

20. The method of claim 19 further comprising playing back at least some said digital audio content on a car radio.

21. A system for listening to digital audio content according to location comprising:
a) a car radio including a playback effecter; and
b) a onboard navigation device, wherein said playback effecter is operatively connected to said onboard navigation device.

22. The system of claim 21 further comprising:
c) a non-volatile memory device operatively connected to said car radio.

23. The system of claim 22 wherein said non-volatile memory device physically contacts said car radio.

24. The system of claim 22 wherein said car radio receives digital audio content from said non-volatile memory device using a wireless connection.

25. The system of claim 22 wherein said non-volatile memory device includes a flash memory device.

26. A system comprising:
a) a car radio capable of generating speech from digital text content.

27. The system of claim 26 wherein said car radio is mounted in a motor vehicle and said car radio is operatively connected to a playback effecter mounted in said motor vehicle.

28. The system of claim 27 wherein said playback effecter is physically mounted to a steering wheel.

29. The system of claim 27 wherein said playback effecter includes a voice command recognizer.

30. The system of claim 27 wherein said playback effecter includes rear seat audio controls.

31. The system of claim 27 wherein said playback effecter is contained within said car radio.

32. The system of claim 27 wherein said playback effecter is operatively connected to an onboard navigation device.

33. The system of claim 26 further comprising:
b) a non-volatile memory device operatively connected to said car radio.

34. The system of claim 33 wherein said non-volatile memory device physically contacts said car radio.

35. The system of claim 33 wherein said car radio receives digital content from said non-volatile memory device using a wireless connection.
